(19) United States
(12) Patent Application Publication
(10) Pub. No.: US 2026/0206845 A1
(43) Pub. Date: Jul. 23, 2026

(54) AEROSOL-GENERATING ARTICLE

(71) Applicant: Philip Morris Products S.A., Neuchatel (CH)

(72) Inventor: Matteo BOLOGNA, Lausanne (CH)

(73) Assignee: Philip Morris Products S.A., Neuchatel (CH)

(21) Appl. No.: 19/134,947

(22) PCT Filed: Dec. 21, 2023
(86) PCT No.: PCT/EP2023/087258

§ 371 Date: Jun. 2, 2025

(30) Foreign Application Priority Data
Dec. 23, 2022 (EP) 22216422

(51) Int. Cl. A24F 40/42; A24B 15/167; A24F 40/48; H05B 6/10

(52) U.S. Cl. CPC A24F 40/42; A24B 15/167; A24F 40/48; H05B 6/108

(57) ABSTRACT

An aerosol-generating article for an aerosol-generating device is provided, the aerosol-generating article including: a substantially planar upper surface and a substantially planar lower surface, the substantially planar upper surface and the substantially planar lower surface being vertically spaced from each other by a height defined in a z direction; an aerosol-forming substrate; and one or more susceptor materials arranged in thermal communication with the aerosol-forming substrate, one or more strips, threads, or wires of the one or more susceptor materials being located within an air-flow path of the aerosol-generating article, and/or one or more sheets or layers of the one or more susceptor materials being located within or at least partially defining an air-flow path of the aerosol-generating article.

The present disclosure relates to an aerosol-generating article comprising an aerosol-forming substrate.

A typical aerosol-generating article may appear similar to a conventional cigarette. For example, such an aerosol-generating article may be a substantially cylindrical article comprising an aerosol-forming substrate and other components such as mouthpiece filter element, all wrapped in a cigarette paper. Dimensions of typical aerosol-generating articles are often similar to the dimensions of conventional cigarettes.

Research has shown that, in such a typical aerosol-generating article comprising a plug of aerosol-forming substrate, a significant portion of the plug of aerosol-forming substrate may not be sufficiently heated to form an aerosol during use. This is undesirable since this portion of the plug of aerosol-forming substrate contributes to the cost of manufacture and transport of the aerosol-generating article, but does not contribute to the aerosol delivered to an end user. This may be the case regardless of the way in which the aerosol-forming substrate is heated, for example regardless of whether a resistive or inductive heater is used and regardless of whether the plug of aerosol-forming substrate is heated from the inside or the outside.

It is an aim of the present disclosure to provide an aerosol-generating article, in which a greater portion of an aerosol-forming substrate of the aerosol-generating article is sufficiently heated to form an aerosol during use.

According to the present disclosure, there may be provided an aerosol-generating article comprising an aerosol-forming substrate for producing an aerosol, the aerosol-generating article being a planar aerosol-generating article having a base defined by a length extending in an x direction, a width extending in a y direction, and a height extending in a z direction. The aerosol-generating article may further comprise one or more susceptor materials arranged in thermal communication with the aerosol-forming substrate.

According to the present disclosure, there may be provided an aerosol-generating article comprising an aerosol-forming substrate for producing an aerosol, the aerosol-generating article comprising a substantially planar upper surface defined by a length extending in an x direction and a width extending in a y direction, and a substantially planar lower surface defined by a length extending in an x direction and a width extending in a y direction. The substantially planar upper surface and the substantially planar lower surface may be vertically spaced from each other by a height defined in a z direction. The aerosol-generating article may further comprise one or more susceptor materials arranged in thermal communication with the aerosol-forming substrate.

According to the present disclosure, there may be provided an aerosol-generating article for use with an aerosol-generating device. By way of example, the aerosol-generating article may be as described in any of the preceding paragraphs. The aerosol-generating article may comprise a substantially planar upper surface and a substantially planar lower surface. The upper surface and the lower surface may be vertically spaced from each other by a height defined in a z direction. The aerosol-generating article may further comprise an aerosol-forming substrate and one or more susceptor materials. The one or more susceptor materials may be arranged in thermal communication with the aerosol-forming substrate.

The substantially planar upper surface may be defined by a length extending in an x direction and a width extending in a y direction.

The substantially planar lower surface may be defined by a length extending in an x direction and a width extending in a y direction.

The one or more susceptor materials may serve as a heater for imparting heat to the aerosol-generating article. Heating of the one or more susceptor materials may occur when the aerosol-generating article is placed within a changing magnetic field, with the changing magnetic field resulting in heating of the susceptor material(s) by one or both of eddy current heating and magnetic hysteresis. Such a changing magnetic field may result from an alternating current being supplied to an inductor coil. Preferably, the inductor coil forms a component part of an aerosol-generating device to which the aerosol-generating article may be coupled.

The aerosol-generating article of the present disclosure is generally flat and thin. The provision of a generally flat and thin aerosol-generating article, combined with one or more susceptor materials arranged in thermal communication with the aerosol-forming substrate, provides for rapid and efficient heating of the aerosol-forming substrate and improved uniformity in through-thickness heating. The aerosol-forming substrate is preferably porous and/or of low density, thereby reducing the resistance to air flow through the aerosol-forming substrate (for example, where the aerosol-generating article has an air flow path extending through the aerosol-generating article). Preferably, the aerosol-generating article is free of any single-use plastics, thereby providing an aerosol-generating article with improved sustainability.

Preferably, one or more susceptor materials may be in direct contact with the aerosol-forming substrate.

Advantageously, one or more susceptor materials may be incorporated within the aerosol-forming substrate. Particles of susceptor material may be dispersed within the aerosol-forming substrate.

One or more susceptor materials may be incorporated within the aerosol-generating article as one or more strips, threads, or wires of susceptor material. One or more strips, threads, or wires of susceptor material may be located within an air-flow path of the aerosol-generating article.

One or more susceptor materials may be incorporated within the aerosol-generating article as one or more sheets or layers of susceptor material. One or more sheets or layers of susceptor material may be located within or at least partially define an air-flow path of the aerosol-generating article. One or more sheets or layers of susceptor material may cover an external portion of the aerosol-generating article. One or more sheets or layers of susceptor material may form a structural component of the aerosol-generating article. At least one of the one or more sheets or layers of susceptor material may be formed as a mesh of susceptor material.

Advantageously, the aerosol-generating article may comprise a plurality of susceptor regions spaced apart from each other and arranged in thermal communication with the aerosol-forming substrate, the plurality of susceptor regions comprising or consisting of one or more susceptor materials. The spacing apart of different susceptor regions from each other allows for selective heating of different regions or portions of aerosol-forming substrate by different ones of the susceptor regions. Conveniently, the plurality of susceptor regions may be spaced apart from each other in an x direction. The plurality of susceptor regions may comprise one or more susceptor materials overlaid on or incorporated into a paper-based substrate or aerosol-forming substrate.

The susceptor material(s) may comprise one or more materials selected from a list consisting of: aluminium, iron and iron alloys, nickel and nickel alloys, cobalt alloys, stainless steel alloys, copper alloys, carbon, expanded carbon, and graphite.

The upper surface and the lower surface may be parallel to each other.

The aerosol-generating article may extend over its length between a distal end and a proximal end. The aerosol-forming substrate may extend over at least part of the length of the aerosol-generating article. The aerosol-forming substrate may extend over part of the length of the aerosol-generating article and be positioned to be closer to the distal end than to the proximal end. In other embodiments, the aerosol-forming substrate may extend over the entire length of the aerosol-generating article. The aerosol-forming substrate may extend to the distal end. The proximal end may be a mouth end of the aerosol-generating article.

Aerosol-generating articles according to the present disclosure may preferably be substantially flat articles or substantially planar articles. Such articles have a large base area relative to the volume of the article. Advantageously, a larger base area may provide greater surface area for heating by a planar heater of an aerosol-generating device. Advantageously, a smaller height may allow a smaller temperature gradient or difference across the height of the aerosol-generating article during heating. For example, where the base of the aerosol-generating article is in contact with, and heated by, a planar heater, there may be a smaller temperature difference between the base and an upper surface opposing the base if the spacing, or height, between the base and the upper surface is smaller. Advantageously, this may allow heating of a greater proportion of the aerosol-forming substrate of the aerosol-generating article to a temperature at which an aerosol is released, whilst minimising the risk of burning the hottest portion of the substrate closest to the heater. Alternatively, or in addition, this may reduce a time required to heat the aerosol-forming substrate sufficiently to release an aerosol.

The aerosol-generating article according to any of the aspects disclosed herein may have an air flow path extending through the aerosol-generating article. The aerosol-generating article may have an air-flow path defined through the aerosol-generating article in an x/y plane from one side of the aerosol-generating article to the other side of the aerosol-generating article. The aerosol-generating article preferably has a resistance to draw (RTD) of less than 20 millimetre H₂O, for example less than 10 millimetre H₂O, in the direction of the airflow path. Preferably, the aerosol-generating article has a RTD of less than 20 millimetre H₂O, for example less than 10 millimetre H₂O, in at least one direction in an x/y plane of the aerosol-generating article. An aerosol-generating article with a low resistance air-flow path may allow for superior air-flow management and allow aerosol to be extracted more efficiently from the aerosol-generating article and guided to a user.

Unless otherwise specified, the resistance to draw (RTD) is measured in accordance with ISO 6565-2015. The RTD refers to the pressure required to force air through the full length of a component, such as the aerosol-generating article. The terms “pressure drop” or “draw resistance” of a component or article may also refer to the “resistance to draw”. Such terms generally refer to the measurements made in accordance with ISO 6565-2015 and are normally carried out at under test at a volumetric flow rate of about 17.5 millilitres per second at the output or downstream end of the measured component at a temperature of about 22 degrees Celsius, a pressure of about 101 kPa (about 760 Torr) and a relative humidity of about 60%.

The aerosol-generating article according to any of the aspects disclosed herein may comprise substantially planar upper and lower surfaces. A vertical separation between the substantially planar upper and lower surfaces may define a height (for example, a z dimension) of the aerosol-generating article. An air flow channel may be defined between the substantially planar upper and lower surfaces. The height of the aerosol-generating article may be less than 5 millimetres, for example between 1.5 millimetres and 5 millimetres, for example between 1.5 millimetres and 4 millimetres, for example between 1.5 millimetres and 3 millimetres, for example between 1.5 millimetres and 2 millimetres. One or both of the substantially planar upper and lower surfaces may comprise an aerosol-forming substrate. The aerosol-generating article may comprise upper and lower layers, at least one of the upper and lower layers comprising or consisting of aerosol-forming substrate, the upper layer forming the substantially planar upper surface and the lower layer forming the substantially planar lower surface.

The aerosol-generating article may further comprise an intermediate layer arranged between an upper layer and a lower layer. The upper surface may define an external surface of the upper layer and the lower surface may define an external surface of the lower layer. An air-flow path may be defined through the aerosol-generating article in an x/y plane between a distal end and a proximal end of the aerosol-generating article.

A resistance to draw (RTD) of the aerosol-generating article, along the air-flow path, may be less than 20 millimetres H₂O.

Preferably, at least one of the upper layer, the intermediate layer and the lower layer comprise or consist of one or more susceptor materials.

At least one of the upper layer, the intermediate layer and the lower layer may comprise a plurality of susceptor regions spaced apart from each other, the plurality of susceptor regions comprising or consisting of one or more susceptor materials. The spacing apart of different susceptor regions from each other allows for selective heating of different regions or portions of aerosol-forming substrate by different ones of the susceptor regions. The plurality of susceptor regions may be spaced apart from each other in an x-direction.

Both of the upper and lower layers may comprise or consist of aerosol-forming substrate and the intermediate layer may comprise or consist of one or more susceptor materials.

Both of the upper and lower layers may comprise or consist of one or more susceptor materials and the intermediate layer may comprise or consist of aerosol-forming substrate.

One or both of the upper layer and the lower layer may comprise or consist of aerosol-forming substrate and one or more susceptor materials. One or more susceptor materials may be dispersed within aerosol-forming substrate of one or both of the upper layer and the lower layer. One or both of the upper layer and the lower layer may comprise a sub-layer of aerosol-forming substrate laminated with a sub-layer of one or more susceptor materials. The sub-layer of aerosol-forming substrate may define an inward-facing surface of the respective upper or lower layer.

The intermediate layer may comprise or consist of a paper-based substrate.

The intermediate layer may be free of aerosol-forming substrate.

The intermediate layer may comprise or consist of aerosol-forming substrate. The intermediate layer may further comprise one or more susceptor materials.

The intermediate layer may be free of susceptor material.

One or more strips, threads, or wires of susceptor material may be located within an air-flow path defined by the intermediate layer.

A plurality of longitudinally extending channels may be defined by corrugations between the upper layer and the intermediate layer and between the intermediate layer and the lower layer. The longitudinally extending channels may extend along in an x/y plane between the distal end and the proximal end. One or more strips, threads, or wires of susceptor material may be disposed in one or more of the corrugations.

In examples where one or more strips, threads, or wires of susceptor material are located within an air-flow path defined by the intermediate layer, or are disposed in one or more of the corrugations, the intermediate layer may comprise or consist of aerosol-forming substrate.

The intermediate layer may be fixed relative to at least one of the upper layer and lower layer by an adhesive. For example, the adhesive may comprise guar gum. The adhesive may comprise an aerosol-forming material such as homogenised tobacco slurry.

The intermediate layer may comprise a corrugated element.

The intermediate layer may comprise a plurality of corrugated elements. Two or more of the plurality of corrugated elements may be arranged in vertical relationship to each other between the upper layer and the lower layer. One or more of the plurality of corrugated elements may comprise one or more susceptor materials and other one or ones of the plurality of corrugated elements may comprise aerosol-forming substrate. The intermediate layer may further comprise a planar element positioned between two of the plurality of corrugated elements. The planar element may comprise or consist of one or more susceptor materials.

According to the present disclosure, there may be provided an aerosol-generating article comprising a first planar layer, a second planar layer, and a corrugated layer arranged between the first planar layer and the second planar layer. At least one of the first planar layer, the second planar layer and the corrugated layer may comprise or consist of an aerosol-forming substrate. The aerosol-generating article may further comprise one or more susceptor materials arranged in thermal communication with the aerosol-forming substrate. The susceptor materials may be as described in any of the preceding paragraphs.

The use of a corrugated structure in the aerosol-generating article may advantageously allow the production of an aerosol-generating article that has extremely low RTD while still being sufficiently rigid to for a user to handle. Further, use of a corrugated structure may allow a low density, low RTD, aerosol-generating article to be produced using high speed production methods similar to those used for production of corrugated cardboard.

The aerosol-generating article may further comprise a planar frame positioned between an upper layer and a lower layer. The upper surface may define an external surface of the upper layer and the lower surface may define an external surface of the lower layer. The planar frame may define a cavity. An air flow path may be defined through the aerosol-generating article in an x/y plane, the air-flow path extending through the cavity.

The upper layer and the lower layer may be coupled to opposing surfaces of the frame to overlie opposing ends of the cavity.

One or both of the upper layer and the lower layer may comprise or consist of one or more susceptor materials.

Advantageously, at least one of the upper layer and the lower layer may comprise a plurality of susceptor regions spaced apart from each other, the plurality of susceptor regions comprising or consisting of one or more susceptor materials. The plurality of susceptor regions may be spaced apart from each other in an x-direction.

One or both of the upper layer and the lower layer may comprise or consist of aerosol-forming substrate and one or more susceptor materials.

One or more susceptor materials may be dispersed within aerosol-forming substrate of one or both of the upper layer and the lower layer.

One or both of the upper layer and the lower layer may comprise a sub-layer of aerosol-forming substrate laminated with a sub-layer of one or more susceptor materials. The sub-layer of aerosol-forming substrate may define an inward-facing surface of the respective upper or lower layer.

The aerosol-generating article may further comprise one or more of particles, shreds, or a sheet of aerosol-forming substrate disposed within the cavity between the upper and lower layers. The upper layer and the lower layer may be free of aerosol-forming substrate.

A corrugated element may be disposed within the cavity between the upper and lower layers. A plurality of longitudinally extending channels are defined by corrugations between the upper layer and the corrugated element and between the corrugated element and the lower layer. The longitudinally extending channels may extend along in an x/y plane between opposing ends of the frame. One or strips, threads, or wires of susceptor material are disposed in one or more of the corrugations. The corrugated element may comprise or consist of aerosol-forming substrate. The outer layer and the inner layer may be free of aerosol-forming substrate.

The air-flow path may be at least partially defined by the frame. The frame may comprise an inlet air-flow channel and an outlet air-flow channel, the inlet air-flow channel configured to permit a flow of air into the cavity and the outlet air-flow channel configured to permit a flow of air to exit the cavity. The inlet air-flow channel and the outlet air-flow channel may be defined on opposing ends of the frame. The inlet air-flow channel may be defined in a first width edge of the frame and the outlet air-flow channel defined in a second width edge of the frame.

According to the present disclosure, there may be provided an aerosol-generating article, the aerosol-generating article comprising: a first planar external surface, a second planar external surface, a cavity, a frame positioned between the first planar external surface and the second planar external surface, the frame at least partially defining the cavity, an aerosol-forming substrate positioned between the first planar external surface and the second planar external surface, and an air inlet and an air outlet, and an airflow passage extending between the air inlet and the air outlet through the cavity. The aerosol-generating article may further comprise one or more susceptor materials arranged in thermal communication with the aerosol-forming substrate. The susceptor materials may be as described in any of the preceding paragraphs.

The frame may comprise a peripheral wall at least partially circumscribing or encircling the cavity. The frame may comprise a peripheral wall wholly circumscribing or encircling the cavity. The aerosol-generating article may comprise a first planar external layer and a second planar external layer, in which the first planar external layer forms the first planar external surface and the second planar external layer forms the second planar external surface. Optionally, at least one of the first planar external layer, the second planar external layer, and the frame may comprise or consist of aerosol-forming substrate.

The cavity may be substantially empty.

Aerosol-forming substrate may be positioned within the cavity.

A corrugated layer may be positioned within the cavity.

The aerosol-generating article of any of the aspects of the present disclosure may have a length (for example, an x dimension) of between 10 millimetres and 100 millimetres, or between 10 millimetres and 50 millimetres, for example between 12 millimetres and 30 millimetres, for example between 14 millimetres and 26 millimetres, for example between 16 millimetres and 24 millimetres, for example between 18 millimetres and 22 millimetres, for example about 18 millimetres, or about 19 millimetres, or about 20 millimetres, or about 21 millimetres, or about 22 millimetres.

The aerosol-generating article may have a width (for example, a y dimension) of between 5 millimetres and 20 millimetres, for example between 8 millimetres and 18 millimetres, for example between 10 millimetres and 16 millimetres, for example between 11 millimetres and 15 millimetres, for example between 12 millimetres and 14 millimetres, for example about 13 millimetres.

The aerosol-generating article may have a height (for example, a z dimension) of between 1 millimetres and 10 millimetres, for example between 1.2 millimetres and 8 millimetres, for example between 1.4 millimetres and 7 millimetres, for example between 1.6 millimetres and 6 millimetres, for example between 1.7 millimetres and 5 millimetres, for example about 1.7 millimetres, or about 4.5 millimetres, or about 2 millimetres, or about 3 millimetres, or about 4 millimetres.

The aerosol-generating article of any of the aspects of the present disclosure when viewed in plan may have a shape defining a polygon, a quadrilateral (for example, a rectangle or a square), oval, or circle, or a combination thereof. Where the aerosol-generating article comprises substantially planar upper and lower surfaces, one or both of the upper and lower surfaces when viewed in plan may have a shape defining a polygon, a quadrilateral (for example, a rectangle or a square), an oval, a circle, or a combination thereof. A perimeter of the aerosol-generating article when viewed in plan may be formed of a plurality of straight sides, a plurality of curved sides, or a combination of straight and curved sides. Where the aerosol-generating article comprises substantially planar upper and lower surfaces, a perimeter of one or both of the upper and lower surfaces when viewed in plan may have a shape defining a polygon, a quadrilateral (for example, a rectangle or a square), an oval, a circle, or a combination thereof.

The aerosol-forming substrate may comprise nicotine. Nicotine may be present in the form of a tobacco material or may be in the form of a nicotine extract.

Preferably, the aerosol-forming substrate comprises, or consists of, homogenised tobacco material, for example a reconstituted tobacco material or a cast leaf tobacco material.

The aerosol-forming substrate may comprise, or consist of, a solid aerosol-forming material. The aerosol-forming substrate may comprise a liquid aerosol-forming material, for example a liquid aerosol-forming material retained within a porous matrix. The aerosol-forming substrate may comprise a gel aerosol-forming material.

The aerosol-forming substrate may comprise one or more aerosol-formers. Suitable aerosol-formers are well known in the art and include, but are not limited to, one or more aerosol-formers selected from: polyhydric alcohols, such as propylene glycol, polyethylene glycol, triethylene glycol, 1, 3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. It may be particularly preferable for the aerosol-former to be or comprise glycerine.

The aerosol-forming substrate may comprise at least 1, 2, 5, 10, or 15 weight percent aerosol-former. The aerosol-forming substrate may comprise greater than 15 weight percent aerosol-former, for example greater than 20 weight percent, or greater than 25 weight percent, or greater than 30 weight percent, or greater than 40 weight percent, or greater than 50 weight percent aerosol-former.

The aerosol-forming substrate may comprise less than or equal to 30 percent by weight of aerosol former, less than or equal to 25 percent by weight of aerosol former, or less than or equal to 20 percent by weight of aerosol former. That is, the aerosol-forming substrate may have an aerosol former content of less than or equal to 30 percent by weight, less than or equal to 25 percent by weight, or less than or equal to 20 percent by weight.

The aerosol-forming substrate may comprise between 1 percent and 30 percent by weight of aerosol former, between 1 percent and 25 percent by weight of aerosol former, or between 1 percent and 20 percent by weight of aerosol former.

The aerosol-forming substrate may comprise between 5 percent and 30 percent by weight of aerosol former, between 5 percent and 25 percent by weight of aerosol former, or between 5 percent and 20 percent by weight of aerosol former.

The aerosol-forming substrate may comprise between 10 percent and 30 percent by weight of aerosol former, between 10 percent and 25 percent by weight of aerosol former, or between 10 percent and 20 percent by weight of aerosol former.

The aerosol-forming substrate may comprise between 15 percent and 30 percent by weight of aerosol former, between 15 percent and 25 percent by weight of aerosol former, or between 15 percent and 20 percent by weight of aerosol former.

The aerosol-forming substrate may comprise at least 50 percent by weight of aerosol former, at least 60 percent by weight of aerosol former, or at least 70 percent by weight of aerosol former.

The aerosol-forming substrate may comprise less than or equal to 85 percent by weight of aerosol former, less than or equal to 80 percent by weight of aerosol former, or less than or equal to 75 percent by weight of aerosol former.

The aerosol-forming substrate may comprise between 50 percent and 85 percent by weight of aerosol former, between 50 percent and 80 percent by weight of aerosol former, or between 50 percent and 75 percent by weight of aerosol former.

The aerosol-forming substrate may comprise between 60 percent and 85 percent by weight of aerosol former, between 60 percent and 80 percent by weight of aerosol former, or between 60 percent and 75 percent by weight of aerosol former.

The aerosol-forming substrate may comprise between 70 percent and 85 percent by weight of aerosol former, between 70 percent and 80 percent by weight of aerosol former, or between 70 percent and 75 percent by weight of aerosol former.

The aerosol-forming substrate may comprise nicotine. The aerosol-forming material may comprise natural nicotine, or synthetic nicotine, or a combination of natural nicotine and synthetic nicotine.

The aerosol-forming substrate may comprise at least 0.5 percent by weight of nicotine, at least 1 percent by weight of nicotine, at least 1.5 percent by weight of nicotine, or at least 2 percent by weight of nicotine. That is, the aerosol-forming substrate may have a nicotine content of at least 0.5 percent by weight, at least 1 percent by weight, at least 1.5 percent by weight, or at least 2 percent by weight.

The aerosol-forming substrate may comprise one or more cannabinoid compounds such as one or more of: tetrahydrocannabinol (THC), tetrahydrocannabinolic acid (THCA), cannabidiol (CBD), cannabidiolic acid (CBDA), cannabinol (CBN), cannabigerol (CBG), cannabigerol monomethyl ether (CBGM), cannabivarin (CBV), cannabidivarin (CBDV), tetrahydrocannabivarin (THCV), cannabichromene (CBC), cannabicyclol (CBL), cannabichromevarin (CBCV), cannabigerovarin (CBGV), cannabielsoin (CBE), cannabicitran (CBT). It may be preferable that the cannabinoid compound is CBD or THC. It may be particularly preferable that the cannabinoid compound is CBD.

The aerosol-forming substrate may comprise one or more flavourants. The one or more flavourants may comprise one or more of: one or more essential oils such as eugenol, peppermint oil and spearmint oil; one or both of menthol and eugenol; one or both of anethole and linalool; and a herbaceous material. Suitable herbaceous material includes herb leaf or other herbaceous material from herbaceous plants including, but not limited to, mints, such as peppermint and spearmint, lemon balm, basil, cinnamon, lemon basil, chive, coriander, lavender, sage, tea, thyme, and caraway. The one or more flavourants may comprise a tobacco material.

The aerosol-forming substrate may have a moisture content of about 5 to 25%, preferably of about 7 to 15%, at final product state. For example, the aerosol-forming substrate may be a homogenised tobacco material with a moisture of about 5 to 25%, preferably of about 7 to 15%, at final product state.

The aerosol-forming substrate may comprise tobacco leaf; for example about 15 to 45%, preferably of about 20 to 35% of a blend of tobacco leaf, incorporating at least one of the following tobacco types: bright tobacco; dark tobacco; aromatic tobacco. Tobacco material such as tobacco leaf is preferably ground and graded to a particle size of about 100 to 380 mesh, preferably of about 170 to 320 mesh.

“Tobacco type” means one of the different varieties of tobacco, for example based on the distinct curing process that the tobacco undergoes before it is further processed in a tobacco product.

Examples of bright tobaccos are Flue-Cured Brazil, Indian Flue-Cured, Chinese Flue-Cured, US Flue-Cured such as Virginia tobacco, and Flue-Cured from Tanzania.

Examples of aromatic tobaccos are Oriental Turkey, Greek Oriental, semi-oriental tobacco but also Fire Cured, US Burley, such as Perique, and Rustica.

Examples of dark tobacco are Dark Cured Brazil Galpao, Burley Malawi or other African Burley, Sun Cured or Air Cured Indonesian Kasturi.

The aerosol-forming substrate may comprise Cellulose fibres. For example, the aerosol-forming substrate may comprise about 1 to 15% of cellulose fibres, preferably of about 3 to 7% of cellulose fibres. Preferably, cellulose fibres may have a length of about 10 to 250 μm, preferably of about 10 to 120 μm.

The aerosol-forming substrate may comprise organic fibres such as non-tobacco fibres, or tobacco fibres. For example, the aerosol-forming substrate may comprise about 5 to 20%, preferably about 7 to 15% of tobacco fibres. Tobacco fibres are preferably derived from stems and/or or stalks, graded to fibres of a length of about 10 to 350 μm, preferably of about 10 to 180 μm. The aerosol-forming substrate may comprise about 10 to 30 %, preferably of about 15 to 25%, of a non-tobacco organic fibre. For example, organic fibres may derive from cellulose, cotton, wood, tea botanical varieties as sub-products, and sub-processed waste, the tea industry. Organic fibres are preferably of a length of about 10 to 400 μm, preferably of about 10 to 200 μm. The aerosol-forming substrate may comprise a binder. For example, the aerosol-forming substrate may comprise about 1 to 10%, preferably of about 1 to 5%, of a binder such as any of common gums or pectins used in food and beverage (F&B) industries. Preferred binders may be natural pectins, such as fruit, for example citrus, or tobacco pectins; guar gums, land locust bean gums, such as hydroxyethyl and/or hydroxypropyl of those; starches, such as modified or derivatized starches; alginate; methyl, ethyl, ethylhydroxymethyl and carboxymethyl, celluloses; dextran; and xanthan gum. A preferable binder is guar.

The aerosol-forming substrate may comprise an organic botanical glycerite. For example, the aerosol-forming substrate may comprise about 15 to 55 %, preferably of about 20 to 35 %, of botanicals such as Clove, Echinacea sp., Fennel, Ginger, Hawthorn berry, Elderberry, Monarda, Mullein leaves, Nettle, Plantain, Turmeric, Yarrow, and compounds of those.

The aerosol-forming substrate may comprise organic botanical extracts. For example, the aerosol-forming substrate may comprise about 1 to 15 %, preferably of about 2 to 7 %, of any of the previously referred botanicals, as well as menthol (dl-Menthol, C₁₀H₂₀O, 2-Isopropyl-5-methylcyclohexanol) such as obtained from Chaerophyllum macrospermum, Mesosphaerum sidifolium, or other related botanic varieties, as well as P-menthan-3-ol, as any secondary alcohol as diastereoisomers of 5-methyl-2-(propan-2-yl)cyclohexan-1-ol.

The aerosol-forming substrate may comprise botanical essential oils, for example about 0.5 to 5 %, preferably of about 1 to 3 %, of a botanical essential oil, for example a botanical essential oil such as of palm, coconut, and wooden-based essential oils.

The aerosol-forming substrate preferably comprises an aerosol-former, for example about 5 to 35%, preferably of about 10 to 25%, of an aerosol former. Suitable aerosol-formers known in the art include: glycerine; monohydric alcohols like menthol, polyhydric alcohols, such as triethylene glycol; esters of polyhydric alcohols, such as glycerol mono-, di- or triacetate; and aliphatic esters of mono-, di- or polycarboxylic acids, such as dimethyls of those.

As used herein, the term “aerosol-generating article” may refer to an article able to generate, or release, an aerosol.

As used herein, the term “aerosol-forming substrate” may refer to a substrate capable of releasing an aerosol or volatile compounds that can form an aerosol. Such volatile compounds may be released by heating the aerosol-forming substrate. An aerosol-forming substrate may comprise an aerosol-forming material. An aerosol-forming substrate may be adsorbed, coated, impregnated, or otherwise loaded onto a carrier or support. An aerosol-forming substrate may conveniently be part of an aerosol-generating article or smoking article.

As used herein, the term “aerosol-generating device” may refer to a device for use with an aerosol-generating article to enable the generation, or release, of an aerosol.

As used herein, the term “aerosol generating system” refers to a combination of an aerosol-generating device and one or more aerosol-forming articles for use with the device. An aerosol-generating system may include additional components, such as a charging unit for recharging an on-board electric power supply in an electrically operated or electric aerosol-generating device. As used herein, the term “aerosol former” may refer to any suitable known compound or mixture of compounds that, in use, facilitates formation of an aerosol. The aerosol may be a dense and stable aerosol. The aerosol may be substantially resistant to thermal degradation at the operating temperature of the aerosol-forming substrate or aerosol-generating article.

As used herein with reference to the invention, the term “nicotine”, is used to describe nicotine, nicotine base or a nicotine salt.

As used herein with reference to the invention, the terms “proximal”, “distal”, “upstream” and “downstream” are used to describe the relative positions of components, or portions of components, of the aerosol-generating article.

As used herein, the term “longitudinal” refers to the direction corresponding to the main longitudinal axis of the aerosol-generating article, which extends between the upstream and downstream ends of the aerosol-generating article. During use, air may be drawn through the aerosol-generating article in the longitudinal direction.

As used herein, the term “sheet” denotes a laminar element having a width and length substantially greater than the thickness thereof. The width of a sheet may be greater than 10 mm, preferably greater than 20 mm or 30 mm. In certain embodiments, sheets of material for use in forming aerosol-forming substrates as described herein may have a thickness of between 10 μm and about 1000 μm, for example between 10 μm and about 300 μm.

As used herein, the term “homogenised tobacco material” encompasses any tobacco material formed by the agglomeration of particles of tobacco material. Sheets or webs of homogenised tobacco material are formed by agglomerating particulate tobacco obtained by grinding or otherwise powdering of one or both of tobacco leaf lamina and tobacco leaf stems. In addition, homogenised tobacco material may comprise a minor quantity of one or more of tobacco dust, tobacco fines, and other particulate tobacco by-products formed during the treating, handling and shipping of tobacco. The sheets of homogenised tobacco material may be produced by casting, extrusion, paper making processes or other any other suitable processes known in the art.

The term “cast leaf” is used herein to refer to a product made by a casting process that is based on casting a slurry comprising plant particles (for example, clove particles or tobacco particles and clove particles in a mixture) and a binder (for example, guar gum) onto a supportive surface, such as a belt conveyor, drying the slurry and removing the dried sheet from the supportive surface. An example of the casting or cast leaf process is described in, for example, U.S. Pat. No. 5,724,998A for making cast leaf tobacco. In a cast leaf process, particulate plant materials are produced by pulverizing, grinding, or comminuting parts of the plant. The particles produced from one or more plants are mixed with a liquid component, typically water, to form a slurry. Other components in the slurry may include fibres, a binder and an aerosol former. The particulate plant materials may be agglomerated in the presence of the binder. The slurry is cast onto a supportive surface and dried into a sheet of homogenized plant material. Preferably, homogenized plant material used in articles according to the present invention may be produced by casting. Such homogenized plant material may comprise agglomerated particulate plant material.

As used herein, resistance to draw is expressed with the units of pressure “mm H₂O” or “mm WG” or “mm of water gauge” and may be measured in accordance with ISO 6565:2002.

The invention is defined in the claims. However, below there is provided a non-exhaustive list of non-limiting examples. Any one or more of the features of these examples may be combined with any one or more features of another example, embodiment, or aspect described herein.

Example Ex1: An aerosol-generating article for use with an aerosol-generating device, the aerosol-generating article comprising a substantially planar upper surface and a substantially planar lower surface, the upper surface and the lower surface vertically spaced from each other by a height defined in a z direction, the aerosol-generating article further comprising an aerosol-forming substrate and one or more susceptor materials, the one or more susceptor materials arranged in thermal communication with the aerosol-forming substrate.

Example Ex 2: An aerosol-generating article according to Ex 1, wherein one or more susceptor materials are in direct contact with the aerosol-forming substrate.

Example Ex 3: An aerosol-generating article according to either one of Ex 1 or Ex 2, wherein one or more susceptor materials are incorporated within the aerosol-forming substrate.

Example Ex4: An aerosol-generating article according to Ex3, wherein particles of susceptor material are dispersed within the aerosol-forming substrate.

Example Ex5: An aerosol-generating article according to any one of Ex1 to Ex4, wherein one or more susceptor materials are incorporated within the aerosol-generating article as one or more strips, threads, or wires of susceptor material.

Example Ex6: An aerosol-generating article according to Ex5, wherein one or more strips, threads, or wires of susceptor material are located within an air-flow path of the aerosol-generating article.

Example Ex7: An aerosol-generating article according to any one of Ex1 to Ex6, wherein one or more susceptor materials are incorporated within the aerosol-generating article as one or more sheets or layers of susceptor material.

Example Ex8: An aerosol-generating article according to Ex7, wherein one or more sheets or layers of susceptor material are located within or at least partially define an air-flow path of the aerosol-generating article.

Example Ex9: An aerosol-generating article according to either one of Ex7 or Ex8, wherein one or more sheets or layers of susceptor material cover an external portion of the aerosol-generating article.

Example Ex10: An aerosol-generating article according to any one of Ex7 to Ex9, wherein one or more sheets or layers of susceptor material form a structural component of the aerosol-generating article.

Example Ex11: An aerosol-generating article according to any of Ex7 to Ex10, wherein at least one of the one or more sheets or layers of susceptor material is formed as a mesh of susceptor material.

Example Ex12: An aerosol-generating article according to any one of Ex1 to Ex11, comprising a plurality of susceptor regions spaced apart from each other and arranged in thermal communication with the aerosol-forming substrate, the plurality of susceptor regions comprising or consisting of one or more susceptor materials.

Example Ex13: An aerosol-generating article according to Ex12, wherein the plurality of susceptor regions are spaced apart from each other in an x direction.

Example Ex14: An aerosol-generating article according to either one of Ex12 or Ex13, wherein the plurality of susceptor regions comprise one or more susceptor materials overlaid on or incorporated into a paper-based substrate or aerosol-forming substrate.

Example Ex15: An aerosol-generating article according to any one of Ex1 to Ex14, wherein the susceptor material comprises one or more materials selected from a list consisting of: aluminium, iron and iron alloys, nickel and nickel alloys, cobalt alloys, stainless steel alloys, copper alloys, carbon, expanded carbon, and graphite.

Example Ex16: An aerosol-generating article according to any one of Ex1 to Ex15, wherein the upper surface and the lower surface are parallel to each other.

Example Ex17: An aerosol-generating article according to any one of Ex1 to Ex16, wherein the aerosol-generating article extends over its length between a distal end and a proximal end, the aerosol-forming substrate extending over at least part of the length of the aerosol-generating article, optionally the aerosol-forming substrate extending over the entire length of the aerosol-generating article.

Example Ex18: An aerosol-generating article according to Ex17, wherein the aerosol-forming substrate extends over part of the length of the aerosol-generating article and is positioned to be closer to the distal end than to the proximal end.

Example Ex19: An aerosol-generating article according to either one of Ex17 or Ex18, wherein the aerosol-forming substrate extends to the distal end.

Example Ex20: An aerosol-generating article according to any one of Ex17 to Ex19, wherein the proximal end is a mouth end of the aerosol-generating article.

Example Ex21: An aerosol-generating article according to any one of Ex1 to Ex20, further comprising an intermediate layer arranged between an upper layer and a lower layer, the upper surface defining an external surface of the upper layer and the lower surface defining an external surface of the lower layer, wherein an air-flow path is defined through the aerosol-generating article in an x/y plane between a distal end and a proximal end of the aerosol-generating article.

Example Ex22: An aerosol-generating article according to Ex21, wherein a resistance to draw (RTD) of the aerosol-generating article, along the air-flow path, is less than 20 millimetres H₂O.

Example Ex23: An aerosol-generating article according to either one of Ex21 or Ex22, wherein at least one of the upper layer, the intermediate layer and the lower layer comprise or consist of one or more susceptor materials.

Example Ex24: An aerosol-generating article according to Ex23, wherein at least one of the upper layer, the intermediate layer and the lower layer comprise a plurality of susceptor regions spaced apart from each other, the plurality of susceptor regions comprising or consisting of one or more susceptor materials.

Example Ex25: An aerosol-generating article according to Ex24, wherein the plurality of susceptor regions are spaced apart from each other in an x-direction.

Example Ex26: An aerosol-generating article according to any one of Ex23 to Ex25, wherein both of the upper and lower layers comprise or consist of aerosol-forming substrate and the intermediate layer comprises or consists of one or more susceptor materials.

Example Ex27: An aerosol-generating article according to any one of Ex23 to Ex25, wherein both of the upper and lower layers comprise or consist of one or more susceptor materials and the intermediate layer comprises or consists of aerosol-forming substrate.

Example Ex28: An aerosol-generating article according to any one of Ex23 to Ex27, wherein one or both of the upper layer and the lower layer comprise or consist of aerosol-forming substrate and one or more susceptor materials.

Example Ex29: An aerosol-generating article according to Ex28, wherein one or more susceptor materials are dispersed within aerosol-forming substrate of one or both of the upper layer and the lower layer.

Example Ex30: An aerosol-generating article according to either one of Ex28 or Ex29, wherein one or both of the upper layer and the lower layer comprise a sub-layer of aerosol-forming substrate laminated with a sub-layer of one or more susceptor materials.

Example Ex31: An aerosol-generating article according to Ex30, wherein the sub-layer of aerosol-forming substrate defines an inward-facing surface of the respective upper or lower layer.

Example Ex32: An aerosol-generating article according to any one of Ex28 to Ex31, wherein the intermediate layer comprises or consists of a paper-based substrate.

Example Ex33: An aerosol-generating article according to any one of Ex28 to Ex32, wherein the intermediate layer is free of aerosol-forming substrate.

Example Ex34: An aerosol-generating article according to any one of Ex28 to Ex32, wherein the intermediate layer comprises or consists of aerosol-forming substrate.

Example Ex35: An aerosol-generating article according to Ex34, wherein the intermediate layer further comprises one or more susceptor materials.

Example Ex36: An aerosol-generating article according to any one of Ex28 to Ex34, wherein the intermediate layer is free of susceptor material.

Example Ex37: An aerosol-generating article according to any one of Ex21 to Ex36, wherein one or more strips, threads, or wires of susceptor material are located within an air-flow path defined by the intermediate layer.

Example Ex38: An aerosol-generating article according to any one of Ex21 to Ex37, wherein a plurality of longitudinally extending channels are defined by corrugations between the upper layer and the intermediate layer and between the intermediate layer and the lower layer. Example Ex39: An aerosol-generating article according to Ex38, wherein the longitudinally extending channels extend along in an x/y plane between the distal end and the proximal end.

Example Ex40: An aerosol-generating article according to either one of Ex38 or Ex39, wherein one or more strips, threads, or wires of susceptor material are disposed in one or more of the corrugations.

Example Ex41: An aerosol-generating article according to either one of Ex37 or Ex40, wherein the intermediate layer comprises or consists of aerosol-forming substrate.

Example Ex42: An aerosol-generating article according to any one of Ex21 to Ex41, wherein the intermediate layer is fixed relative to at least one of the upper layer and lower layer by an adhesive, for example in which the adhesive comprises guar gum, optionally in which the adhesive comprises an aerosol-forming material such as homogenised tobacco slurry.

Example Ex43: An aerosol-generating article according to any one of Ex21 to Ex42, wherein the intermediate layer comprises a corrugated element.

Example Ex44: An aerosol-generating article according to Ex43, wherein the intermediate layer comprises a plurality of corrugated elements, in which two or more of the plurality of corrugated elements are arranged in vertical relationship to each other between the upper layer and the lower layer.

Example Ex45: An aerosol-generating article according to Ex44, wherein one or more of the plurality of corrugated elements comprise one or more susceptor materials and other one or ones of the plurality of corrugated elements comprise aerosol-forming substrate.

Example Ex46: An aerosol-generating article according to either one of Ex44 or Ex45, wherein the intermediate layer further comprises a planar element positioned between two of the plurality of corrugated elements.

Example Ex47: An aerosol-generating article according to Ex46, wherein the planar element comprises or consists of one or more susceptor materials.

Example Ex48: An aerosol-generating article according to any one of Ex1 to Ex20, further comprising a planar frame positioned between an upper layer and a lower layer, the upper surface defining an external surface of the upper layer and the lower surface defining an external surface of the lower layer, the planar frame defining a cavity, wherein an air flow path is defined through the aerosol-generating article in an x/y plane, the air-flow path extending through the cavity.

Example Ex49: An aerosol-generating article according to Ex48, wherein the upper layer and the lower layer are coupled to opposing surfaces of the frame to overlie opposing ends of the cavity.

Example Ex50: An aerosol-generating article according to either one of Ex48 or Ex49, wherein one or both of the upper layer and the lower layer comprise or consist of one or more susceptor materials.

Example Ex51: An aerosol-generating article according to Ex50, wherein at least one of the upper layer and the lower layer comprise a plurality of susceptor regions spaced apart from each other, the plurality of susceptor regions comprising or consisting of one or more susceptor materials.

Example Ex52: An aerosol-generating article according to Ex51, wherein the plurality of susceptor regions are spaced apart from each other in an x-direction.

Example Ex53: An aerosol-generating article according to any one of Ex50 to Ex52, wherein one or both of the upper layer and the lower layer comprise or consist of aerosol-forming substrate and one or more susceptor materials.

Example Ex54: An aerosol-generating article according to Ex53, wherein one or more susceptor materials are dispersed within aerosol-forming substrate of one or both of the upper layer and the lower layer.

Example Ex55: An aerosol-generating article according to either one of Ex53 or Ex54, wherein one or both of the upper layer and the lower layer comprise a sub-layer of aerosol-forming substrate laminated with a sub-layer of one or more susceptor materials.

Example Ex56: An aerosol-generating article according to Ex55, wherein the sub-layer of aerosol-forming substrate defines an inward-facing surface of the respective upper or lower layer. Example Ex57: An aerosol-generating article according to any one of Ex48 to Ex56, further comprising one or more of particles, shreds, or a sheet of aerosol-forming substrate disposed within the cavity between the upper and lower layers.

Example Ex58: An aerosol-generating article according to Ex57, wherein the upper layer and the lower layer are free of aerosol-forming substrate.

Example Ex59: An aerosol-generating article according to any one of Ex48 to Ex58, wherein a corrugated element is disposed within the cavity between the upper and lower layers.

Example Ex60: An aerosol-generating article according to Ex59, wherein a plurality of longitudinally extending channels are defined by corrugations between the upper layer and the corrugated element and between the corrugated element and the lower layer.

Example Ex61: An aerosol-generating article according to Ex60, wherein the longitudinally extending channels extend along in an x/y plane between opposing ends of the frame.

Example Ex62: An aerosol-generating article according to either one of Ex60 or Ex61, wherein one or strips, threads, or wires of susceptor material are disposed in one or more of the corrugations.

Example Ex63: An aerosol-generating article according to any one of Ex59 to Ex62, wherein the corrugated element comprises or consists of aerosol-forming substrate.

Example Ex64: An aerosol-generating article according to Ex63, wherein the outer layer and the inner layer are free of aerosol-forming substrate.

Example Ex65: An aerosol-generating article according to any one of Ex48 to Ex64, wherein the air-flow path is at least partially defined by the frame.

Example Ex66: An aerosol-generating article according to Ex65, wherein the frame comprises an inlet air-flow channel and an outlet air-flow channel, the inlet air-flow channel configured to permit a flow of air into the cavity and the outlet air-flow channel configured to permit a flow of air to exit the cavity.

Example Ex67: An aerosol-generating article according to Ex66, wherein the inlet air-flow channel and the outlet air-flow channel are defined on opposing ends of the frame.

Example Ex68: An aerosol-generating article according to either one of Ex66 or Ex67, wherein the inlet air-flow channel is defined in a first width edge of the frame and the outlet air-flow channel is defined in a second width edge of the frame.

Examples will now be further described with reference to the figures in which:

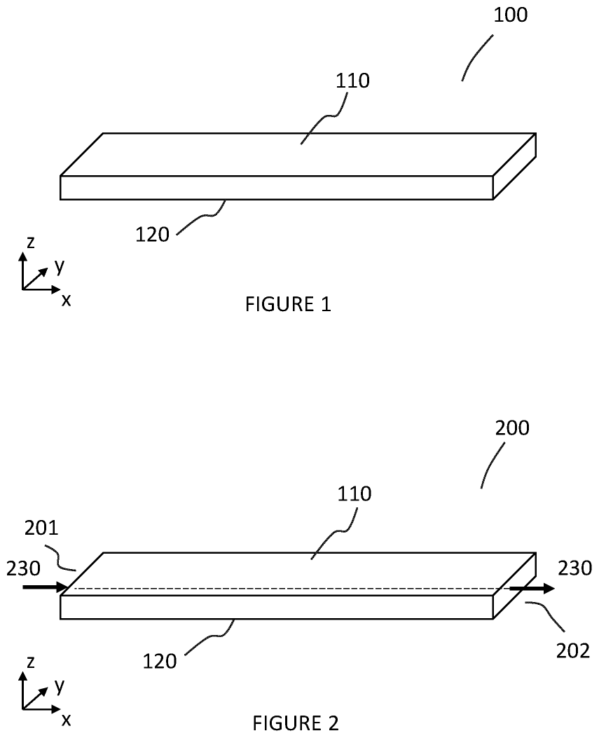

FIG. 1 is a perspective side view of an aerosol-generating article according to a first embodiment of the present disclosure;

FIG. 2 is a perspective side view of an aerosol-generating article according to a second embodiment of the present disclosure;

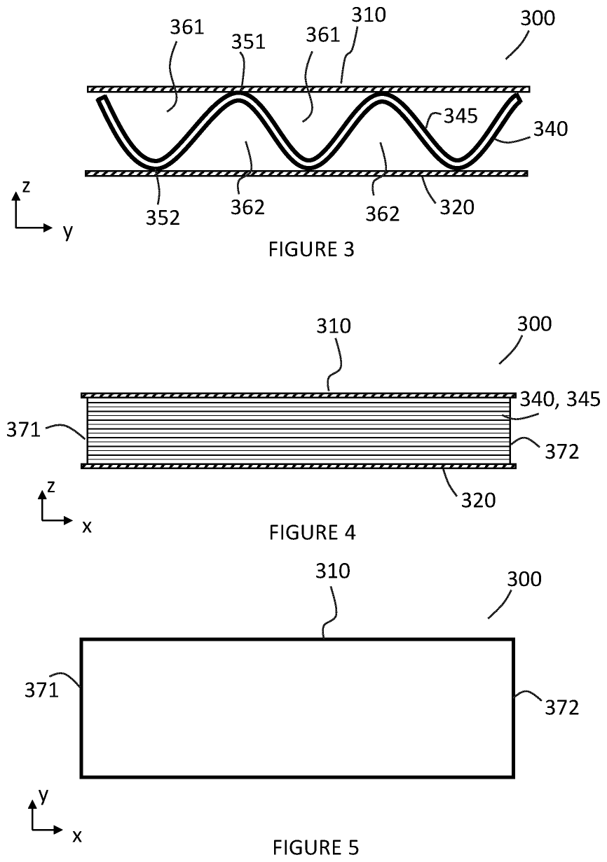

FIG. 3 is a schematic end view of an aerosol-generating article according to a third embodiment of the present disclosure;

FIG. 4 is a schematic side view of the aerosol-generating article of FIG. 3;

FIG. 5 is a schematic plan view of the aerosol-generating article of FIG. 3;

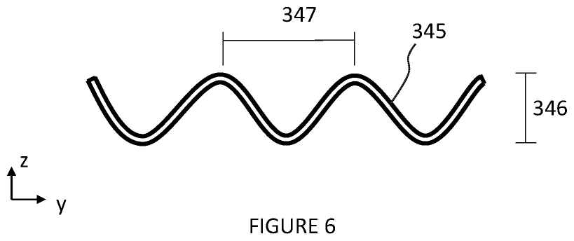

FIG. 6 shows a schematic illustration of a corrugated element as used in the aerosol-generating article of FIG. 3;

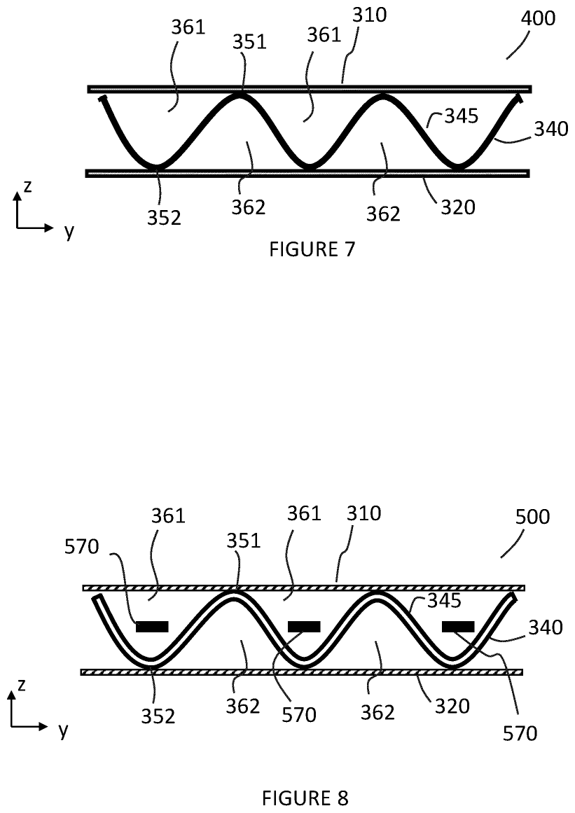

FIG. 7 is a schematic end view of an aerosol-generating article according to a fourth embodiment of the present disclosure;

FIG. 8 is a schematic end view of an aerosol-generating article according to a fifth embodiment of the present disclosure;

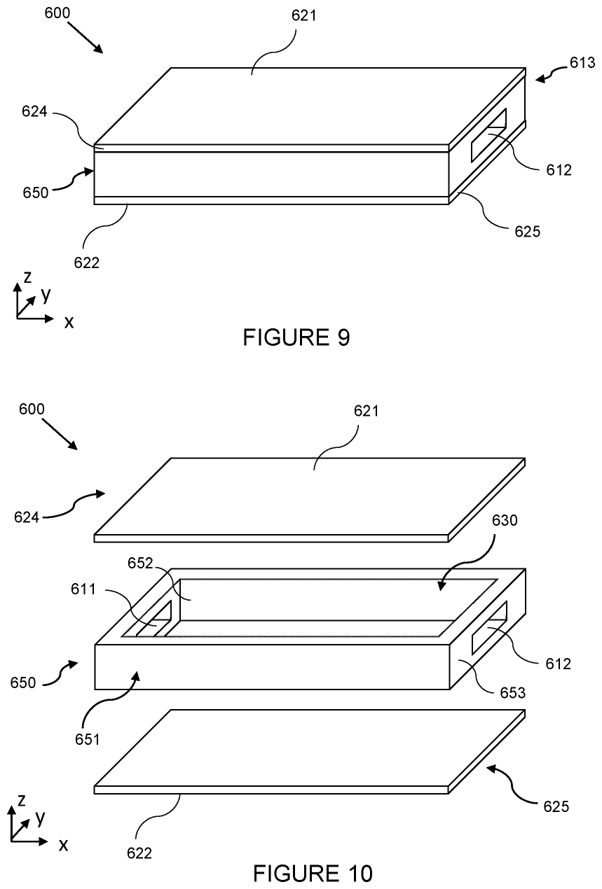

FIG. 9 shows a perspective view of an aerosol-generating article according to a sixth embodiment of the present disclosure;

FIG. 10 shows an exploded perspective view of the aerosol-generating article of FIG. 9;

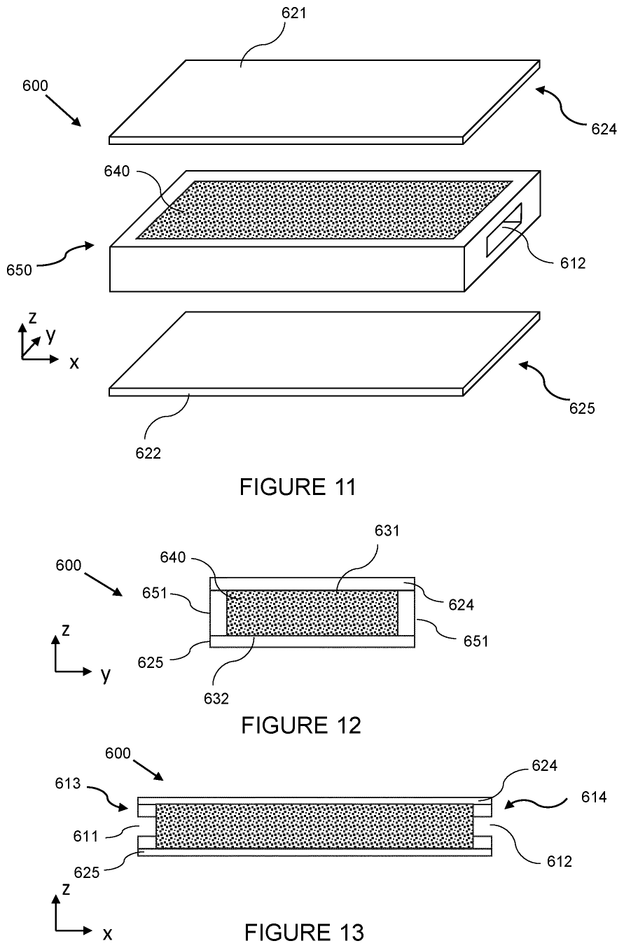

FIG. 11 shows a further exploded perspective view of the aerosol-generating article of FIG. 9;

FIG. 12 shows a schematic transverse cross-sectional view of the aerosol-generating article of FIG. 9;

FIG. 13 shows a schematic longitudinal cross-sectional view of the aerosol-generating article of FIG. 9;

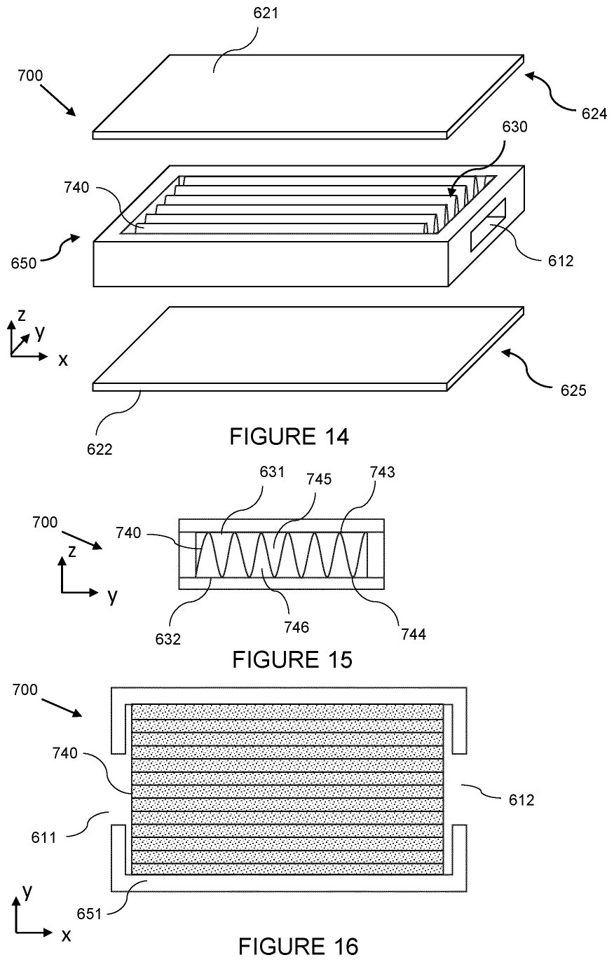

FIG. 14 shows an exploded perspective view of an aerosol-generating article according to a seventh embodiment of the present disclosure;

FIG. 15 shows a schematic transverse cross-sectional view of the aerosol-generating article of FIG. 14;

FIG. 16 shows a schematic lateral cross-sectional view of the aerosol-generating article of FIG. 14;

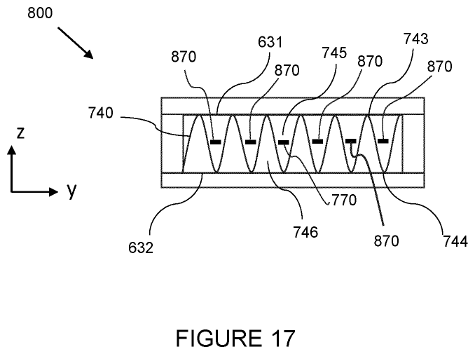

FIG. 17 shows a schematic transverse cross-sectional view of an aerosol-generating article according to an eighth embodiment of the present disclosure, being a variant to the aerosol-generating article of FIGS. 14 to 16;

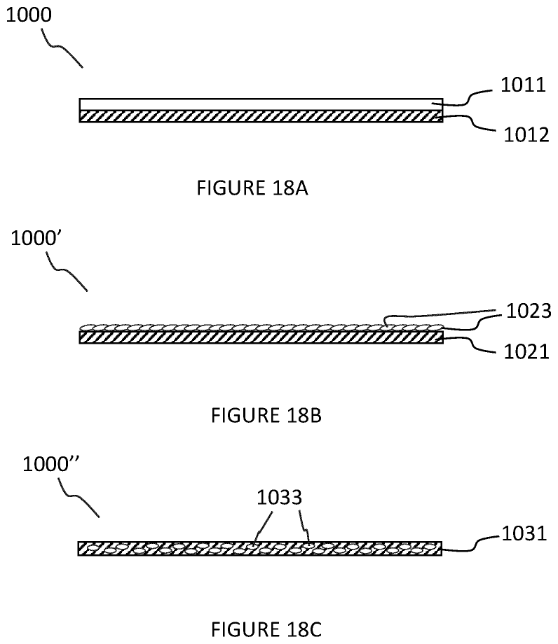

FIGS. 18A to 18C are cross-sectional views of different composite structures containing one or more susceptor materials for use in the aerosol-generating articles of the present disclosure, such as the aerosol-generating articles of FIGS. 1 to 17;

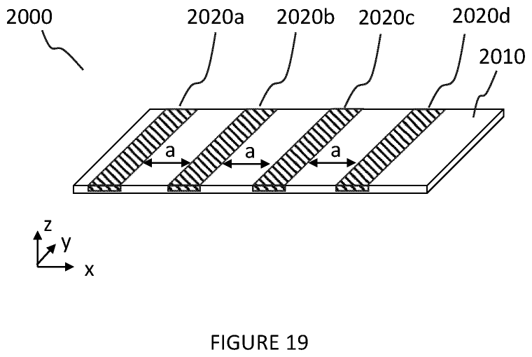

FIG. 19 is a perspective view of a composite structure incorporating spaced-apart sheets of susceptor material, for use in the aerosol-generating articles of the present disclosure.

FIG. 1 illustrates a perspective side view of an aerosol-generating article 100 according to a first embodiment of the present disclosure. The aerosol-generating article 100 has upper and lower surfaces 110, 120 which are flat or planar.

The aerosol-generating article 100 comprises an aerosol-forming substrate and one or more susceptor materials (not shown). In one embodiment, the aerosol-generating article 100 may consist substantially of aerosol-forming substrate and one or more susceptor materials. In another embodiment, the aerosol-forming substrate and one or more susceptor materials may be a subset of a plurality of component parts of the aerosol-generating article 100. The aerosol-forming substrate may be enclosed within an interior of the aerosol-generating article 100. The aerosol-forming substrate may at least partially define an exterior of the aerosol-generating article 100; for example, one or both of the upper and lower surfaces 110, 120 may comprise or consist of aerosol-forming substrate. The one or more susceptor materials may be enclosed within an interior of the aerosol-generating article 100. The one or more susceptor materials may at least partially define an exterior of the aerosol-generating article 100, for example, one or both of the upper and lower surfaces 110, 120 may comprise or consist of one or more susceptor materials. In further embodiments, one or more susceptor materials and aerosol-forming substrate may be combined to form a composite structure.

The susceptor material(s) may be formed from stainless steel or aluminium.

A suitable aerosol-forming substrate may be homogenised tobacco.

The aerosol-generating article 100 has a length, extending in an x dimension, of 80 millimetres, a width, extending in a y dimension, of 15 millimetres, and a height (which may also be referred to as a thickness), extending in a z dimension, of 3.6 millimetres.

FIG. 2 illustrates a perspective side view of an aerosol-generating article 200 according to a second embodiment of the present disclosure, being a variant of aerosol-generating article 100. In common with aerosol-generating article 100, aerosol-generating article 200 also comprises one or more susceptor materials. Features in common with aerosol-generating article 100 are referred to with like reference signs. An air flow path 230 is defined through the aerosol-generating article 200 between the upper and lower surfaces 110, 120. The air flow path 230 extends between opposed first and second ends 201, 202 of the aerosol-generating article 200. The first end 201 may define a distal end of the aerosol-generating article 200, and the second end 202 may define a proximal end of the aerosol-generating article. The air flow path 230 may be directed towards a mouth of a user to allow a user to inhale aerosol generated in consequence of heating of aerosol-forming substrate of the aerosol-generating article 200.

FIGS. 3, 4, and 5 illustrate respectively an end view, a side view, and a plan view of an aerosol-generating article 300 according to a third embodiment of the present disclosure. The aerosol-generating article 300 comprises a planar upper layer 310, a planar lower layer 320, and an intermediate or separation layer 340 arranged between the upper layer 310 and lower layer 320.

The planar upper layer 310 is formed from a sheet of susceptor material (for example, a sheet of stainless steel or aluminium) having a thickness of 50 microns. The planar lower layer 320 is formed from a sheet of susceptor material (for example, a sheet of stainless steel or aluminium) having a thickness of 50 microns. The intermediate layer 340 is a corrugated element formed from a corrugated sheet of aerosol-forming substrate 345. A suitable aerosol-forming substrate may be homogenised tobacco. Thus, the intermediate layer 340 may be formed from a corrugated sheet of homogenised tobacco material 345.

FIG. 6 illustrates the corrugated sheet of aerosol-forming substrate 345. The corrugations have an amplitude 346 of 3 millimetres and a wavelength 347 of 3 millimetres. The sheet of aerosol-forming substrate 345 forming the intermediate layer 340 has a thickness of 150 microns. Points of intersection 351, 352 between the upper layer 310 and the intermediate layer 340 and between the lower layer 320 and the intermediate layer 340 comprise an adhesive that joins the respective layers.

The aerosol-generating article 300 has a length, extending in an x dimension, of 80 millimetres, a width, extending in a y dimension, of 15 millimetres, and a height (or thickness), extending in a z dimension, of 3.6 millimetres.

Corrugations of the intermediate layer 340 form a first set of longitudinally extending channels 361 that are bounded by the upper layer 310 and the intermediate layer 340, and a second set of longitudinally extending channels 362 bounded by the lower layer 320 and the intermediate layer 340. The first and second sets of longitudinally extending channels 361, 362 extend through the length of the aerosol-forming substrate between a proximal end 371 of the substrate 345 and a distal end 372 of the substrate 345. The longitudinally extending channels 361, 362 define an air-flow path through the substrate 345. The air-flow path, therefore, passes over both sides of the sheet of aerosol-forming substrate 345. The porosity of the aerosol-generating article along the air-flow path is in the region of 90 %. This provides a very low resistance to draw (RTD) of less than 5 mm H₂O. In fact, the RTD is close to zero.

The aerosol-forming substrate 345 may be a sheet of any suitable aerosol-forming substrate.

During use of the aerosol-generating article 300 the article is positioned within a time-varying magnetic field. The variation over time of the magnetic field results in heating of the susceptor materials of the planar upper layer 310 and the planar lower layer 320 (through one or both of eddy current heating or magnetic hysteresis). The time-varying magnetic field may be generated by the supply of an alternating current to an inductor coil of an aerosol-generating device (not shown) to which the aerosol-generating article 300 may be coupled. The heating of the susceptor materials of the planar upper layer 310 and the planar lower layer 320 in turn results in heating of the corrugated sheet of aerosol-forming substrate 345. Heating of the aerosol-forming substrate 345 causes the aerosol-forming substrate 345 to release volatile compounds, which are then entrained in air drawn into the channels 361, 362 via the distal end 372. The volatile compounds then cool and condense to form an aerosol which may be drawn out of the channels 361, 362 of the aerosol-generating article 300 via the proximal end 371.

FIG. 7 illustrates an end view of an aerosol-generating article 400 according to a fourth embodiment of the present disclosure, being a variant of aerosol-generating article 300. Features in common with aerosol-generating article 300 are referred to with like reference signs. For aerosol-generating article 400, the planar upper layer 310 is formed from a sheet of aerosol-forming substrate having a thickness of 150 microns, the planar lower layer 320 is formed from a sheet of aerosol-forming substrate having a thickness of 150 microns and the intermediate layer 340 is a corrugated susceptor element formed from a corrugated sheet of stainless steel or aluminium having a thickness of 50 microns. A suitable aerosol-forming substrate for the planar upper and lower layers 310, 320 may be homogenised tobacco. Thus, the planar upper layer 310 and the planar lower layer 320 may be formed from homogenised tobacco material.

FIG. 8 illustrates an end view of an aerosol-generating article 500 according to a fifth embodiment of the present disclosure, being a variant to aerosol-generating articles 300, 400. Features in common with aerosol-generating articles 300, 400 are referred to with like reference signs. For aerosol-generating article 500, the planar upper layer 310 is formed from a sheet of paper having a thickness of 300 microns, the planar lower layer 320 is formed from a sheet of paper having a thickness of 300 microns and the intermediate layer 340 is a corrugated element formed from a corrugated sheet of aerosol-forming substrate 345 having a thickness of 150 microns. A suitable aerosol-forming substrate for the intermediate layer 340 may be homogenised tobacco. Thus, the intermediate layer 340 may be formed from a corrugated sheet of homogenised tobacco material 345. A longitudinal susceptor strip 570 is located within each of the longitudinally extending channels 361. The susceptor strip 570 may be formed from stainless steel or aluminium.

FIG. 9 shows an aerosol-generating article 600 according to a sixth embodiment of the present disclosure. The aerosol-generating article 600 comprises a first planar external layer 624 forming a first planar external surface 621, a second planar external layer 625 forming a second planar external surface 622, and a frame 650 positioned between the first planar external layer 624 and the second planar external layer 625. The second planar external surface 622 is positioned parallel to the first planar external surface 621.

FIGS. 10 and 11 show exploded views of the aerosol-generating article 600 of FIG. 9. The frame 650 circumscribes and at least partially defines a cavity 630. FIG. 10 shows the cavity 630 in an empty state. FIG. 11 shows the cavity 630 filled with aerosol-forming substrate 640. FIGS. 12 and 13 show respective transverse and longitudinal cross-sectional views of the aerosol-generating article 600 when the cavity 630 is filled with aerosol-forming substrate 640.

The first planar external layer 624 and the second planar external layer 625 are made from a sheet of susceptor material (for example, a sheet of stainless steel or aluminium) having a thickness of 35 micrometres and are in physical contact, with and bonded to, the frame 650. The first planar external layer 624 overlies a first end of the cavity 630 and forms a first cavity end wall 631. The second planar external layer 625 overlies a second end of the cavity 630 and forms a second cavity end wall 632, the second cavity end wall 632 being opposite to the first cavity end wall 631. That is, the frame 650, the first planar external layer 624 and the second planar external layer 625 collectively define the cavity 630.

The frame 650 has a hollow cuboid shape and is made from cardboard. The frame 650 defines an aperture extending through the height (also referred to as the thickness) of the frame 650 and the aperture at least partially forms the cavity 630 of the aerosol-generating article 600. The frame 650 comprises a peripheral wall 651 that circumscribes the cavity 630. The peripheral wall 651 includes a front wall 613 and a back wall 614. In more detail, the peripheral wall 651 is defined by an inner transverse surface 652 of the frame 450 and an outer transverse surface 653 of the frame 650. The inner transverse surface 652 of the peripheral wall 651 at least partially defines a perimeter of the cavity 630. The outer transverse surface 653 of the peripheral wall 651 at least partially defines a perimeter of the aerosol-generating article 600. The peripheral wall 651 has a radial thickness measured between the inner transverse surface 652 of the frame 650 and the outer transverse surface 653 of the frame 650 of about 5 millimetres.

An air inlet 611 and an air outlet 612 are defined by, and extend through, the peripheral wall 651 of the frame 650. More specifically, the air inlet 611 extends through the front wall 613 and the air outlet 612 extends through the back wall 614. The air inlet 611 and the air outlet 612 have an equivalent diameter of 5 millimetres. An airflow passage extends between the air inlet 611 and the air outlet 612 through the cavity 630. As shown in FIGS. 11 to 13, an aerosol-forming substrate 640 is positioned within the cavity 630. The aerosol-forming substrate 640 comprises an aerosol-generating material in the form of tobacco cut filler and has an aerosol-former content of 5 percent by weight on a dry weight basis. As shown, the aerosol-forming substrate 640 fills the entire volume of the cavity 630.

The aerosol-generating article 600 has a cuboid shape and has a height (or thickness) extending in a z dimension, as measured between the first planar external surface 621 and the second planar external surface 622, of 8 millimetres, a width extending in a y dimension of 40 millimetres and a length extending in an x dimension of 60 millimetres. The frame 650 has a height (or thickness) extending in a z dimension of 7.93 millimetres, a width extending in a y dimension of 40 millimetres and a length extending in an x dimension of 60 millimetres. The cavity 630 has a height (or thickness) extending in a z dimension of 7.93 millimetres, a width extending in a y dimension of 39.93 millimetres and a length extending in an x dimension of 52 millimetres. FIG. 14 shows an aerosol-generating article 700 according to a seventh embodiment of the present disclosure. Features in common with aerosol-generating article 600 are referred to with like reference signs. Aerosol-generating article 700 differs from aerosol-generating article 600 in that the aerosol-forming substrate is in the form of a sheet of aerosol-generating material 740, in particular a corrugated sheet of homogenised tobacco material. FIGS. 15 and 16 show respective transverse and lateral cross-section views of the aerosol-generating article 700 of FIG. 14.

The corrugated sheet of homogenised tobacco material 740 comprises a plurality of parallel corrugations having a plurality of substantially parallel peaks 743 and troughs 744. The plurality of parallel corrugations are defined by a corrugation profile which, as seen in FIG. 15, is sinusoidal. The plurality of parallel corrugations have a corrugation wavelength of about 4.6 millimetres. The corrugation amplitude is approximately the same as the height (or thickness) of the cavity 630, as shown by the peaks 743 and troughs 744 coinciding with the first cavity end wall 631 and the second cavity end wall 632, respectively.

The plurality of parallel corrugations form a plurality of channels 745 between the sheet of aerosol-generating material 740 and the first cavity end wall 631, and a plurality of channels 746 between the sheet of aerosol-generating material 740 and the second cavity end wall 632. The plurality of channels 745, 746 extend in a longitudinal direction of the aerosol-generating article 700 and form at least a portion of the airflow passage extending between the air inlet 611 and the air outlet 612.

During use of each of the aerosol-generating articles 600, 700, the article is positioned within a time-varying magnetic field. The variation over time of the magnetic field results in heating of the susceptor materials of the first planar external layer 624 and the second planar external layer 625 (through one or both of eddy current heating or magnetic hysteresis). The time-varying magnetic field may be generated by the supply of an alternating current to an inductor coil of an aerosol-generating device (not shown) to which the aerosol-generating article 600, 700 may be coupled. The heating of the susceptor materials of the first planar external layer 624 and the second planar external layer 625 in turn results in: i) for aerosol-generating article 600, heating of the aerosol-forming substrate 640 disposed inside cavity 630, or ii) for aerosol-generating article 700, heating of the corrugated sheet of aerosol-generating material 740. Heating of the aerosol-forming substrate 640/aerosol-generating material 740 causes the aerosol-forming substrate 640/aerosol-generating material 740 to release volatile compounds, which are then entrained in air drawn through the air inlet 611 into the cavity 630. The volatile compounds then cool and condense to form an aerosol which may be drawn out of the aerosol-generating article 600, 700 through the air outlet 612.

FIG. 17 shows a transverse cross-section of an aerosol-generating article 800 according to an eighth embodiment of the present disclosure, being a variant to aerosol-generating articles 600, 700. Features in common with aerosol-generating articles 600, 700 are referred to with like reference signs. Aerosol-generating article 800 includes all of the features of aerosol-generating article 700 (such as the corrugated sheet aerosol-generating material 740), but additionally includes a longitudinal susceptor strip 870 located within each of the longitudinally extending channels 745 defined between the sheet of aerosol-generating material 740 and the first cavity end wall 631. The susceptor strip 870 may be formed from stainless steel or aluminium. In a variant to the aerosol-generating article 800 of FIG. 17, the first planar external layer 624 and the second planar external layer 625 may be formed from cigarette paper (instead of from a sheet of susceptor material).

As shown for the aerosol-generating articles 300, 400, 500, 600, 700, 800 different component parts of the aerosol-generating article may be formed from susceptor material, with the susceptor material being located in various different locations within the aerosol-generating article.

FIGS. 18A to 18C illustrate various alternative configurations in which susceptor material is integrated or combined with another material to form a composite structure containing susceptor material.

FIG. 18A illustrates an embodiment of a composite structure 1000 suitable for use in an aerosol-generating article (such as any of aerosol-generating articles 100, 200, 300, 400, 500, 600, 700, 800). The composite structure 1000 has a laminate construction defined by a first layer 1011 overlying a second layer 1012. The first layer 1011 is formed from a sheet of a susceptor material, for example, a sheet of stainless steel or aluminium. The second layer 1012 is formed from a sheet of a paper-based substrate. The paper-based substrate may be a substrate formed of paper or cardboard. In an alternative embodiment, an aerosol-forming substrate may be used in place of a paper-based substrate for the second layer 1012. By way of example, the composite structure 1000 may be used to form the planar upper layer 310 or the planar lower layer 320 of aerosol-generating article 300 (see FIG. 3). In another example, the composite structure 1000 may be used to form the corrugated intermediate layer 340 of aerosol-generating article 400 (see FIG. 7). In another example, the composite structure 1000 may be used to form the first planar external layer 624 and the second planar external layer 625 of aerosol-generating article 600 (see FIGS. 9 to 13).

FIG. 18B illustrates a further embodiment of a composite structure 1000′ suitable for use in an aerosol-generating article (such as any of aerosol-generating articles 100, 200, 300, 400, 500, 600, 700, 800). The composite structure 1000′has a layer 1021 and particles or strips of susceptor material 1023 (for example, particles or strips of stainless steel or aluminium) applied over a surface of the layer 1021. The layer 1021 is a sheet formed from a paper-based substrate. The paper-based substrate may be a substrate formed from paper or cardboard. Adhesive (not shown) may be used to facilitate adhesion of the particles or strips of susceptor material 1023 to the surface of the layer 1021. In an alternative embodiment, an aerosol-forming substrate may be used in place of a paper-based substrate for the layer 1021. Again, by way of example, the composite structure 1000′ may be used to form the planar upper layer 310 or the planar lower layer 320 of aerosol-generating article 300 (see FIG. 3). In another example, the composite structure 1000′ may be used to form the corrugated intermediate layer 340 of aerosol-generating article 400 (see FIG. 7). In another example, the composite structure 1000′ may be used to form the first planar external layer 624 and the second planar external layer 625 of aerosol-generating article 600 (see FIGS. 9 to 13).

FIG. 18C illustrates a further embodiment of a composite structure 1000″ suitable for use in an aerosol-generating article (such as any of aerosol-generating articles 100, 200, 300, 400, 500, 600, 700, 800). The composite structure 1000″ has a layer 1031 containing a dispersion of particles or strips of susceptor material 1033 (for example, particles or strips of stainless steel or aluminium). The layer 1031 is a sheet formed from a paper-based substrate. The paper-based substrate may be a substrate formed from paper or cardboard. In an alternative embodiment, an aerosol-forming substrate may be used in place of a paper-based substrate for the layer 1031. Again, by way of example, the composite structure 1000″ may be used to form the planar upper layer 310 or the planar lower layer 320 of aerosol-generating article 300 (see FIG. 3). In another example, the composite structure 1000″ may be used to form the corrugated intermediate layer 340 of aerosol-generating article 400 (see FIG. 7). In another example, the composite structure 1000″ may be used to form the first planar external layer 624 and the second planar external layer 625 of aerosol-generating article 600 (see FIGS. 9 to 13).

FIG. 19 illustrates a composite structure 2000 in the form of a sheet of a paper-based substrate 2010 (such as a sheet of paper or cardboard) incorporating discrete sheets of susceptor material 2020a-d (for example, sheets of aluminium or stainless steel). Each of the sheets of susceptor material 2020a-d are spaced-apart from each other by a distance “a” and define spatially distinct susceptor regions. When employed in an aerosol-generating article (such as any of aerosol-generating articles 100, 200, 300, 400, 500, 600, 700, 800), the composite structure 2000 is preferably arranged so that the discrete sheets of susceptor material 2020a-d are spaced apart from each other along an air flow path or a longitudinal direction (for example, in an x direction) of the aerosol-generating article. By way of example, the composite structure 2000 may be used to form the planar upper layer 310 or the planar lower layer 320 of aerosol-generating article 300 (see FIG. 3). In another example, the composite structure 2000 may be used to form the corrugated intermediate layer 340 of aerosol-generating article 400 (see FIG. 7). In another example, the composite structure 2000 may be used to form the first planar external layer 624 and the second planar external layer 625 of aerosol-generating article 600 (see FIGS. 9 to 13). For exemplary purposes applicable to any of the embodiments described above, a composition of a suitable aerosol-forming substrate may be as follows. Percentages are given in weight percent with respect to the product in its final state. The aerosol-forming substrate may have a moisture of about 5 to 25%, preferably of about 7 to 15%, at final product state. The aerosol-forming substrate may further comprise the following:
1. Tobacco leaf; for example about 15 to 45%, preferably of about 20 to 35% of a blend of tobacco leaf, incorporating at least one of the following tobacco types: bright tobacco; dark tobacco; aromatic tobacco. Tobacco material is ground and graded to a particle size of about 100 to 380 mesh, preferably of about 170 to 320 mesh.
2. Cellulose fibres; for example about 1 to 15%, preferably of about 3 to 7%, of cellulose fibres, of a length of about 10 to 250 μm, preferably of about 10 to 120 μm.
3. Tobacco fibres; for example about 5 to 20%, preferably of about 7 to 15% of tobacco fibres, as filler, of any tobacco type or a blend of tobacco types. Tobacco fibres are preferably derived from stems and/or or stalks, graded to fibres of a length of about 10 to 350 μm, preferably of about 10 to 180 μm.
4. Binder; for example about 1 to 10%, preferably of about 1 to 5%, of a binder such as any of common gums or pectins used in food and beverage (F&B) industries. Preferred binders may be natural pectins, such as fruit, for example citrus, or tobacco pectins; guar gums, land locust bean gums, such as hydroxyethyl and/or hydroxypropyl of those; starches, such as modified or derivatized starches; alginate; methyl, ethyl, ethylhydroxymethyl and carboxymethyl, celluloses; dextran; and xanthan gum. The preferable binder is guar.
5. Aerosol-former; for example about 5 to 35%, preferably of about 10 to 25%, of an aerosol former. Suitable aerosol-formers known in the art include: glycerine; monohydric alcohols like menthol, polyhydric alcohols, such as triethylene glycol; esters of polyhydric alcohols, such as glycerol mono-, di- or triacetate; and aliphatic esters of mono-, di- or polycarboxylic acids, such as dimethyls of those. “Tobacco type” means one of the different varieties of tobacco, for example based on the distinct curing process that the tobacco undergoes before it is further processed in a tobacco product.

For exemplary purposes, a composition of a further aerosol-forming substrate, which may also be suitable for use as the aerosol-forming substrate in any of the embodiments described above is described below. Percentages are given in weight percent with respect to the product in its final state. The aerosol-forming substrate may comprise:
1. An aerosol-former such as Glycerin; for example about 10 to 40 %, preferably of about 20 to 30 %.
2. Organic fibres; for example about 10 to 30 %, preferably of about 15 to 25%, of any botanical variety suitable and with purity to comply with applicable FDA F&B grade requirements, as commonly available in the market. For example, organic fibres may derive from cellulose, cotton, wood, tea botanical varieties as sub-products, and sub-processed waste, of F&B tea industry. Organic fibres are preferably of a length of about 10 to 400 μm, preferably of about 10 to 200 μm.
3. Organic botanical glycerite; for example about 15 to 55 %, preferably of about 20 to 35 %, of botanicals such as Clove, Echinacea sp., Fennel, Ginger, Hawthorn berry, Elderberry, Monarda, Mullein leaves, Nettle, Plantain, Turmeric, Yarrow, and compounds of those.
4. Organic botanical extracts; for example about 1 to 15 %, preferably of about 2 to 7 %, of any of the previously referred botanicals, as well as menthol (dl-Menthol, C₁₀H₂₀O, 2-Isopropyl-5-methylcyclohexanol) such as obtained from Chaerophyllum macrospermum, Mesosphaerum sidifolium, or other related botanic varieties, as well as P-menthan- 3-ol, as any secondary alcohol as diastereoisomers of 5-methyl-2-(propan-2-yl)cyclohexan-1-ol.

Alternatively, such aerosol-forming substrate may also contain botanical essential oils of about 0.5 to 5 %, preferably of about 1 to 3 %, such as of palm, coconut, and wooden-based essential oils.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number “A” is understood as “A” ±10% of “A”. Within this context, a number “A” may be considered to include numerical values that are within general standard error for the measurement of the property that the number “A” modifies. The number “A”, in some instances as used in the appended claims, may deviate by the percentages enumerated above provided that the amount by which “A” deviates does not materially affect the basic and novel characteristic(s) of the claimed invention. Also, all ranges include the maximum and minimum points disclosed and include any intermediate ranges therein, which may or may not be specifically enumerated herein. The terms “in which” and “wherein” are used synonymously through this specification.

1. -15. (canceled)

16. An aerosol-generating article for an aerosol-generating device, the aerosol-generating article comprising:
a substantially planar upper surface and a substantially planar lower surface, the substantially planar upper surface and the substantially planar lower surface being vertically spaced from each other by a height defined in a z direction;
an aerosol-forming substrate; and
one or more susceptor materials arranged in thermal communication with the aerosol-forming substrate,
wherein one or more strips, threads, or wires of the one or more susceptor materials are located within an air-flow path of the aerosol-generating article, and/or
wherein one or more sheets or layers of the one or more susceptor materials are located within or at least partially define an air-flow path of the aerosol-generating article.

17. The aerosol-generating article according to claim 16, wherein the one or more susceptor materials are in direct contact with the aerosol-forming substrate.

18. The aerosol-generating article according to claim 16, wherein the one or more susceptor materials are incorporated within the aerosol-forming substrate.

19. The aerosol-generating article according to claim 18, wherein particles of the one or more susceptor materials are dispersed within the aerosol-forming substrate.

20. The aerosol-generating article according to claim 16, wherein one or more sheets or layers of the one or more susceptor materials cover an external portion of the aerosol-generating article.

21. The aerosol-generating article according to claim 16, wherein one or more sheets or layers of the one or more susceptor materials form a structural component of the aerosol-generating article.

22. The aerosol-generating article according to claim 16, wherein at least one of the one or more sheets or layers of the one or more susceptor materials is formed as a mesh of susceptor material.

23. The aerosol-generating article according to claim 16, further comprising a plurality of susceptor regions spaced apart from each other and arranged in thermal communication with the aerosol-forming substrate, the plurality of susceptor regions comprising the one or more susceptor materials.

24. The aerosol-generating article according to claim 23, wherein the plurality of susceptor regions comprise the one or more susceptor materials overlaid on or incorporated into a paper-based substrate or the aerosol-forming substrate.

25. The aerosol-generating article according to claim 16, wherein the one or more susceptor materials comprises one or more materials selected from a list consisting of: aluminium, iron and iron alloys, nickel and nickel alloys, cobalt alloys, stainless steel alloys, copper alloys, carbon, expanded carbon, and graphite.

26. The aerosol-generating article according to claim 16,
further comprising an intermediate layer arranged between an upper layer and a lower layer, the upper surface defining an external surface of the upper layer and the lower surface defining an external surface of the lower layer,
wherein an air-flow path is defined through the aerosol-generating article in an x/y plane between a distal end and a proximal end of the aerosol-generating article.

27. The aerosol-generating article according to claim 26, wherein at least one of the upper layer, the intermediate layer, and the lower layer comprises the one or more susceptor materials.

28. The aerosol-generating article according to claim 27, wherein at least one of the upper layer, the intermediate layer, and the lower layer comprises a plurality of susceptor regions spaced apart from each other, the plurality of susceptor regions comprising the one or more susceptor materials.

29. The aerosol-generating article according to claim 16,
further comprising a planar frame positioned between an upper layer and a lower layer, the upper surface defining an external surface of the upper layer and the lower surface defining an external surface of the lower layer, the planar frame defining a cavity,
wherein an air flow path is defined through the aerosol-generating article in an x/y plane, the air-flow path extending through the cavity.

30. The aerosol-generating article according to claim 29, wherein one or both of the upper layer and the lower layer comprises the one or more susceptor materials.
